(19) United States
(12) Patent Application Publication
(10) Pub. No.: US 2012/0265413 A1
(43) Pub. Date: Oct. 18, 2012

(54) MULTI-FUNCTIONAL ELECTRONIC CONTROL HANDLEBAR FOR BICYCLE/WALK-ASSISTING VEHICLE

(76) Inventors: SHIH-KANG LIN, Taipei City (TW); Shu-Ling Lu, Taipei City (TW)

(21) Appl. No.: 13/084,578

(22) Filed: Apr. 12, 2011

(51) Int. Cl. F16H 59/00; G06F 19/00

(52) U.S. Cl. 701/51; 701/70

(57) ABSTRACT

A multi-functional electronic control handlebar for bicycle or walk-assisting vehicle includes a control module that is built in a brake lever or a speed-change shifter or is mounted to a brake lever clip or a speed-change shifter clip. When the brake lever or the speed-change shifter is actuated, the brake lever or the speed-change shifter drives the control module to generate an electronic control signal to control a peripheral electronic accessory mounted to the vehicle body.

### TECHNICAL FIELD OF THE INVENTION

The present invention generally relates to a design of bicycle handlebar, and more particularly to a multi-functional electronic control handlebar for bicycle/walk-assisting vehicle, which is operated by actuating a brake lever or a speed-change shifter to control a peripheral electronic accessory mounted to the bicycle frame or body.

### DESCRIPTION OF THE PRIOR ART

The recent continuous increase of fossil fuel price and the concerns about environmental protection make people no longer driving as often as they did. Instead, riding bicycles or taking buses becomes a prevailing way of transportation.

Although the bicycle industry has recently developed various bicycle accessories for meeting the needs of bicycle riders, most of the bicycle accessories are provided for amusement or entertainment of the users, or are provided for simply adding an alarm light to the bicycle frame. Bicycle accessories developed for riding safety purposes are rarely available from the market.

Apparently, there is still a great space for the development and marketing of bicycle accessories and further improvement is needed in this industry.

The present invention thus aims to provide a multi-functional electronic control handlebar for bicycle or walk-assisting vehicle to overcome the above problems.

### SUMMARY OF THE INVENTION

Thus, an objective of the present invention is to provide a control module that is capable of being built in a brake lever or a speed-change shifter, or attached to a brake lever clip or a speed-change shifter clip, whereby the brake lever or the speed-change shifter, once actuated, drives the control module to generate an electronic control signal that is transmitted to a signal receiver module set at any location on the bicycle body to perform a desired operation and thus controlling a peripheral electronic accessory mounted to the bicycle body.

A multi-functional electronic control handlebar for bicycle and/or walk-assisting vehicle is provided to realize the above objective and is composed of a control module that is built in a brake lever or a speed-change shifter and an alarm device. When the brake lever or the speed-change shifter is actuated for operation, the brake lever or the speed-change shifter drives the control module to generate an electronic control signal. The electronic control signal is transmitted from the control module to a signal receiver module set at any location on the vehicle body for performance of an operation to control a peripheral electronic device mounted to the bicycle body.

According to the present invention, a control module is mounted to a brake lever or a brake lever clip, or a speed-change shifter or a speed-change shifter clip, whereby with the actuation of the lever or the clip thereof by a user, the control module is activated to generate an electronic control signal, which, after being transmitted, is applied to control a peripheral electronic accessory mounted to the bicycle body. Thus, the technical solution adopted in the present invention allows a user to control a peripheral electronic accessory mounted to the body of a bicycle by simply actuating the brake lever or the speed-change shifter or a clip thereof.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing a brake lever n which a control module according to the present invention is built.

FIG. 2 is a schematic view showing a speed-change shifter in which a control module according to the present invention is built.

FIG. 3 is a schematic view showing an example structure of a control module according to the present invention.

FIG. 4 is a flow chart of unidirectional control operation according to the present invention.

FIG. 5 is a flow chart of bi-directional control operation according to the present invention.

FIG. 6 is a schematic view illustrating a first example of application of the present invention.

FIG. 7 is a schematic view illustrating a second example of application of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

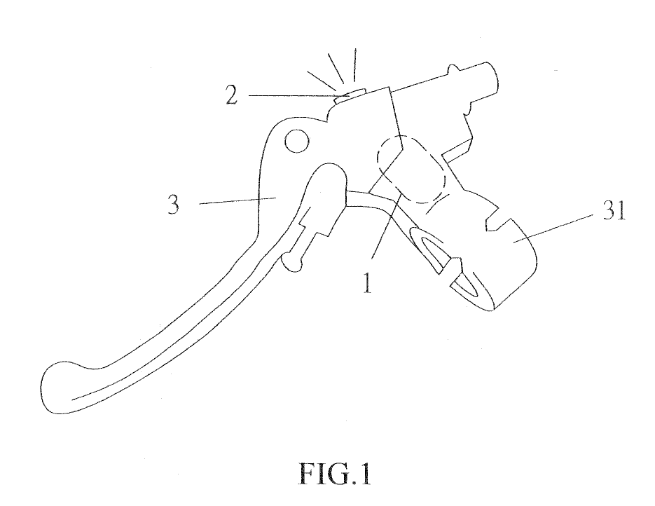

Referring to FIG. 1, a schematic view is given to illustrate a brake lever to which a control module according to the present invention is mounted. As shown, the present invention comprises a control module 1 that is mounted to a brake lever or a brake lever clip and an alarm device 2. The control module 1 is mounted to a brake lever 3 or a brake lever clip 31. When the brake lever 3 or the brake lever clip 31 is actuated for operation, the brake lever 3 or the brake lever clip 31 drives the control module 1 to generate an electronic signal, which is transmitted to a signal receiver module that is set at any location on the vehicle body for performance of an operation to control a peripheral electronic accessory mounted to the vehicle body. The transmission can be done in a unidirectional way or a bi-directional way. The term “bi-directional” used herein means the receiver end, after receiving the signal, transmits a signal through the vehicle body back to the control module for feeding back the situation of the receiver end.

The alarm device 2 is coupled to the brake lever 3 or the brake lever clip 31. The alarm device can be a for example a lighting alarm device.

The term “being mounted to” used herein includes “being built in” or “being externally attached to”, and “being externally attached to” can be done by means of bonding, clamping, or screwing. Further, the electronic signal can be a signal at a frequency of 2.4 GHz or 433 MHz, or a capacitive coupling signal (having a frequency equal to or less than 4 MHz).

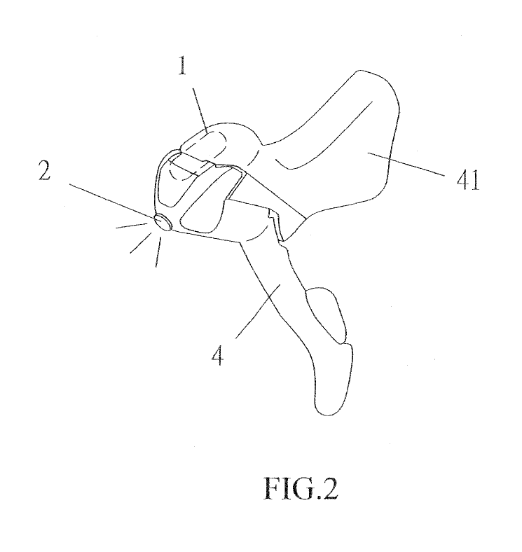

Referring to FIG. 2, a schematic view is given to illustrate a speed-change shifter to which a control module according to the present invention is mounted. As shown, the present invention comprises a control module 1 that is mounted to a speed-changer shifter or a shifter clip and an alarm device 2. The control module 1 is mounted to a speed-change shifter 4 or a shifter clip 41. When the shifter 4 or the shifter clip 41 is actuated for operation, the shifter 4 or the shifter clip 41 drives the control module 1 to generate an electronic control signal, which is transmitted to a signal receiver module set at any location on the vehicle body for performance of an operation to control a peripheral electronic accessory mounted to the vehicle body. The transmission can be done in a unidirectional way or a bi-directional way. The term “bi-directional” used herein means the receiver end, after receiving the signal, transmits a signal back to the control module in the same way of transmission for feeding back the situation of the receiver end.

The alarm device 2 is coupled to the shifter 4 or the shifter clip 41. The alarm device 2 can be for example a lighting alarm device.

The term “being mounted to” used herein includes “being built in” or “being externally attached to”, and “being externally attached to” can be done by means of bonding, clamping, or screwing. Further, the electronic signal can be a signal at a frequency of 2.4 GHz or 433 MHz, or a capacitive coupling signal (having a frequency equal to or less than 4 MHz).

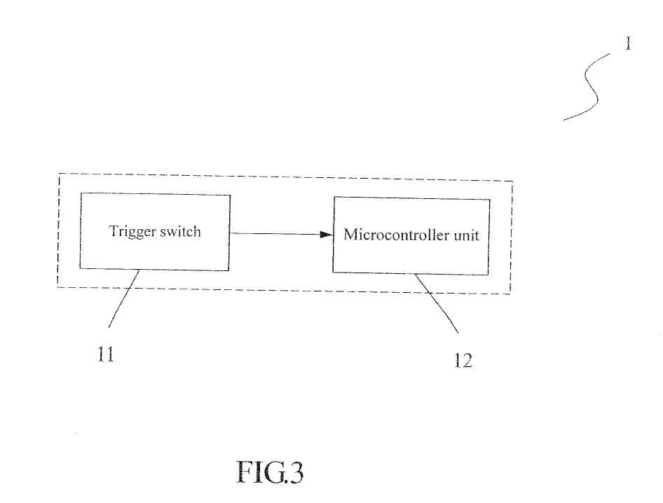

Referring to FIG. 3, a schematic view is given to illustrate an example structure of the control module. As shown in the drawing, the control module 1 comprises a trigger switch 11 and a microcontroller unit 12. When the brake lever 3 or the brake lever clip 31 or the shifter 4 or the shifter clip 41 is actuated for operation, the brake lever 3 or the brake lever clip 31 or the shifter 4 or the shifter clip 41 triggers the trigger switch 11 to generate a signal, which is transmitted to the microcontroller unit 12. The microcontroller unit 12 in turn generates an electronic signal that is transmitted to the signal receiver module. The trigger switch 11 can be a Hall sensor, a magnetic switch, a reed switch, a limit switch, or a touch switch.

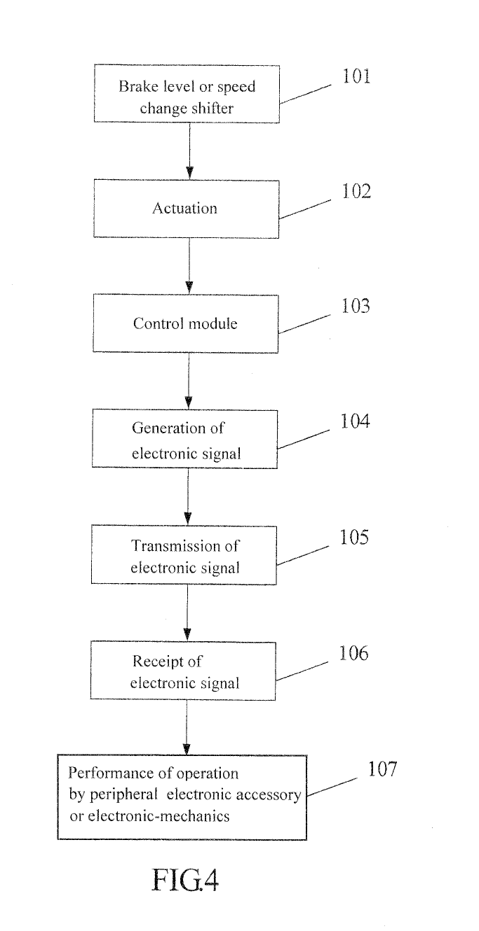

Referring to FIG. 4, a flow chart of unidirectional control operation according to the present invention is shown. As shown in the drawing, the present invention is operated in such a way that a rider riding a bicycle operates a brake lever or a speed-change shifter (Step 101), and the brake lever or the shifter is actuated for operation (Step 102) and activating a control module (Step 103) to make the control module generating an electronic signal (Step 104), which is subjected to an operation of electronic signal transmission (Step 105) to have the electronic control signal sent to a signal receiver module set at any location on a vehicle body for electronic signal reception (Step 106) thereby controlling an peripheral electronic accessory to perform an operation in relation to electronic-mechanics (Step 107).

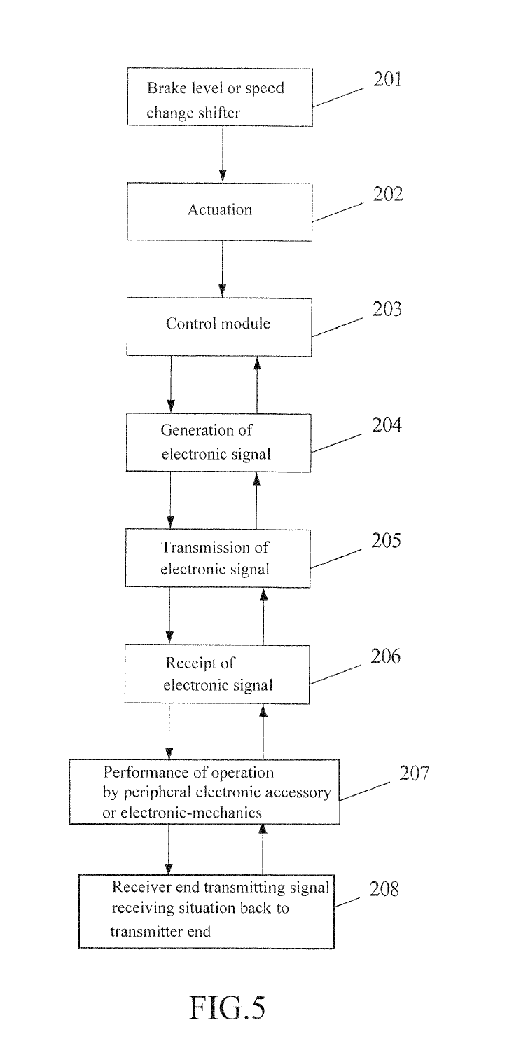

Referring to FIG. 5, a flow chart of bi-directional control operation according to the present invention is shown. As shown in the drawing, the present invention is operated in such a way that a rider riding a bicycle operates a brake lever or a speed-change shifter (Step 201), and the brake lever or the shifter is actuated for operation (Step 202) and activating a control module (Step 203) to make the control module generating an electronic control signal (Step 204), which is subjected to an operation of electronic signal transmission (Step 205) to have the electronic control signal sent to a signal receiver module set at any location on the vehicle body for electronic signal reception (Step 206) thereby controlling an peripheral electronic accessory to perform an operation in relation to electronic-mechanics (Step 207) and then, the receiver end transmits a signal indicating signal receiving situation back to the transmitter end (Step 208), whereby through the reception of the electronic control signal (Step 206) by the peripheral electronic accessory and the electronic-mechanics mentioned in Step 207 and the operation of signal transmission (Step 205), the electronic control signal, after being received (Step 206), is transmitted to the control module (Step 203).

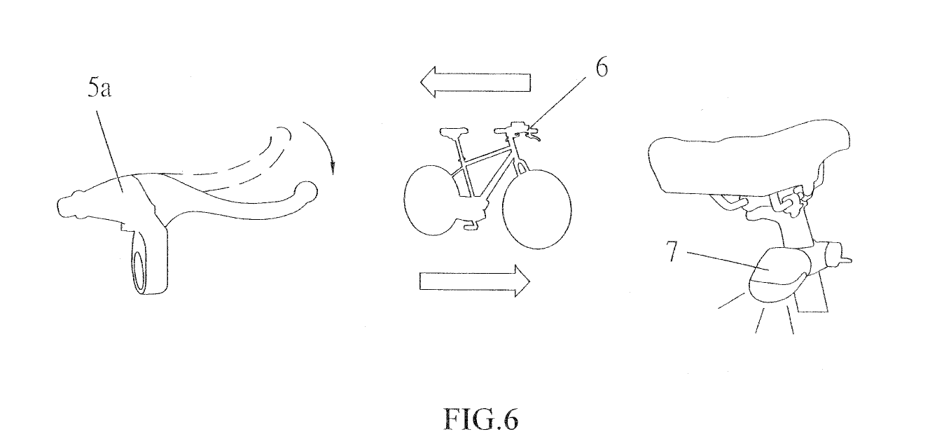

Referring to FIG. 6, a schematic view is given to illustrate a first example of application of the present invention. As shown in drawing, the present invention is operated in such a way that when a brake lever or a brake lever clip 5a is actuated for operation, the brake lever or brake lever clip 5a generates an electronic control signal, which is transmitted to a signal receiver module set at any location on the vehicle body 6 for performance of an operation to control a peripheral electronic accessory 7 mounted to the vehicle body 6.

The peripheral electronic accessory 7 can be for example a turn signal, a buzzer, a servo motor, a gear-shifting device.

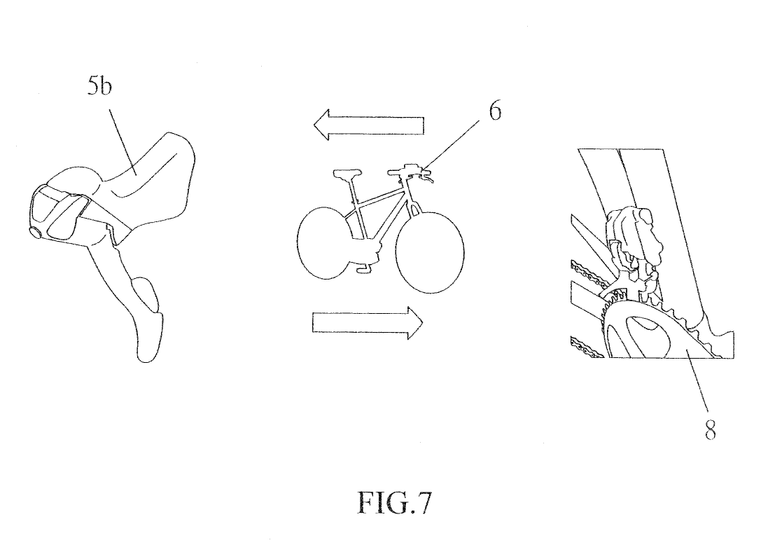

Referring to FIG. 7, a schematic view is given to illustrate a second example of application of the present invention. As shown in the drawing, the present invention is operated in such a way that when a speed-change shifter or a shifter clip 5b is actuated for operation, the shifter or shifter clip 5b generates an electronic control signal, which is transmitted to a signal receiver module set at any location on the vehicle body 6 for performance of an operation to control a speed-change gear 8 mounted to the vehicle body 6.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A multi-functional electronic control handlebar for a bicycle or a walk-assisting vehicle, comprising: a control module, which is adapted to mount in a brake lever or a brake lever clip, whereby when the brake lever or the brake lever clip is actuated for operation, the brake lever or the brake lever clip drives the control module to generate an electronic signal, which is transmitted to a signal receiver module set at a predetermined location on the vehicle body for performance of an operation to control a peripheral electronic accessory mounted to the vehicle body.

2. The multi-functional electronic control handlebar according to claim 1 further comprising an alarm device, which is coupled to the brake lever or the brake lever clip.

3. The multi-functional electronic control handlebar according to claim 2, wherein the alarm device comprises a lighting alarm device.

4. The multi-functional electronic control handlebar according to claim 1, wherein the electronic signal comprises a signal having a frequency of 2.4 GHz or 433 MHz or a capacitive coupling signal (having a frequency equal to or less than 4 MHz).

5. The multi-functional electronic control handlebar according to claim 1, wherein the control module is mounted to the brake lever or the brake lever clip through being built therein or being externally attached thereto.

6. The multi-functional electronic control handlebar according to claim 5, wherein the control module is externally attached to the brake lever or the brake lever clip through bonding, clamping or screwing.

7. The multi-functional electronic control handlebar according to claim 1, wherein the peripheral electronic accessory comprises a turn signal, a buzzer, a servo motor, a gear-shifting device.

8. The multi-functional electronic control handlebar according to claim 1, wherein the signal is transmitted selectively in a unidirectional manner or a bi-directional manner, and the bi-directional manner comprises the receiver end issuing and transmitting a signal back to the control module for feeding back a situation of the receiver end.

9. The multi-functional electronic control handlebar according to claim 1, wherein the control module comprises a trigger switch and a microcontroller unit, whereby when the brake lever or the brake lever clip is actuated for operation, the brake lever or the brake lever clip triggers the trigger switch to generate an electronic signal, which is transmitted to the control module and the control module then generates an electronic control signal that is transmitted to the signal receiver module.

10. The multi-functional electronic control handlebar according to claim 9, wherein the trigger switch comprises one of a Hall sensor, a magnetic switch, a reed switch, a limit switch, and a touch switch.

11. A multi-functional electronic control handlebar for a bicycle or a walk-assisting vehicle, comprising: a control module, which is adapted to mount in a speed-change shifter or a speed-change shifter clip, whereby when the speed-change shifter or the speed-change shifter clip is actuated for operation, the speed-change shifter or the speed-change shifter clip drives the control module to generate an electronic signal, which is transmitted to a signal receiver module set at a predetermined location on the vehicle body for performance of an operation to control a peripheral electronic accessory mounted to the vehicle body.

12. The multi-functional electronic control handlebar according to claim 11 further comprising an alarm device, which is coupled to the speed-change shifter or the speed-change shifter clip.

13. The multi-functional electronic control handlebar according to claim 12, wherein the alarm device comprises a lighting alarm device.

14. The multi-functional electronic control handlebar according to claim 11, wherein the electronic signal comprises a signal having a frequency of 2.4 GHz or 433 MHz or a capacitive coupling signal (having a frequency equal to or less than 4 MHz).

15. The multi-functional electronic control handlebar according to claim 11, wherein the control module is mounted to the speed-change shifter or the speed-change shifter clip through being built therein or being externally attached thereto.

16. The multi-functional electronic control handlebar according to claim 15, wherein the control module is externally attached to the speed-change shifter or the speed-change shifter clip through bonding, clamping or screwing.

17. The multi-functional electronic control handlebar according to claim 11, wherein the peripheral electronic accessory comprises a turn signal, a buzzer, a servo motor, a gear-shifting device.

18. The multi-functional electronic control handlebar according to claim 11, wherein the signal is transmitted selectively in a unidirectional manner or a bi-directional manner, and the bi-directional manner comprises the receiver end issuing and transmitting a signal back to the control module for feeding back a situation of the receiver end.

19. The multi-functional electronic control handlebar according to claim 11, wherein the control module comprises a trigger switch and a microcontroller unit, whereby when the speed-change shifter or the speed-change shifter clip is actuated for operation, the speed-change shifter or the speed-change shifter clip triggers the trigger switch to generate an electronic signal, which is transmitted to the control module and the control module then generates an electronic control signal that is transmitted to the signal receiver module.

20. The multi-functional electronic control handlebar according to claim 19, wherein the trigger switch comprises one of a Hall sensor, a magnetic switch, a reed switch, a limit switch, and a touch switch.
